(19) United States
(12) Patent Application Publication
(10) Pub. No.: US 2009/0061402 A1
(43) Pub. Date: Mar. 5, 2009

(54) Methods And Systems For Providing Interactive Educational Training

(75) Inventor: Kiran Musunuru, New Port Richey, FL (US)

Correspondence Address: Casimir Jones, S.C., 440 Science Drive, Suite 203, Madison, WI, 53711, US

(73) Assignee: Kiran Musunuru

(21) Appl. No.: 11/847,074

(22) Filed: Aug. 29, 2007

(51) Int. Cl. G09B 19/00; G09B 7/00

(52) U.S. Cl. 434/219

(57) ABSTRACT

The present invention provides computer implemented and interactive educational platforms for training professionals, such as healthcare workers. In particular, the present invention provides learning modules for professionals for implementing an interactive curriculum that is designed to ensure thorough coverage of core and advanced competencies.

### FIELD OF THE INVENTION

The present invention provides computer implemented and interactive educational platforms for training professionals, such as healthcare workers. In particular, the present invention provides learning modules for professionals for implementing an interactive curriculum that is designed to ensure thorough coverage of core and advanced competencies.

### BACKGROUND OF THE INVENTION

In recent years, there has been an ever-growing increase in the expense of proper medical education and training. This recent trend spans the entire spectrum of medical disciplines. The high cost of qualified instructors or proctors is responsible for a significant component of these costs. Minimizing, or at least reducing, this cost will reduce the overall cost of medical education and training. As well, instructors and proctors are not available all the time; as such there is no real time training option. Therefore, various devices have been employed to reduce this “live” instructional cost component. It can be appreciated that improved methods of medical training, that provide a cost-effective yet qualitative educational/training regimen, are desired.

Well-rounded knowledge is crucial in the medical field. In order for health care professionals (e.g., medical trainees, doctors, nurses, etc.) to be broadly trained, and to best manage their patients' health, it is important for them to have access to relevant learning tools that provide real-time access to medical information and are updated with current information in their field of practice and/or wide range of medical topics, especially since advancement in the medical field happens at a rapid rate, quickly making much old medical knowledge obsolete. Relevant, up to date knowledge that should be provided in real time includes current information on disease and illness pathology, diagnosis, prevention and treatment, and the latest research and development for the diagnosis, treatment and prevention of various illnesses at any point in time. Educating and training health care professionals as to both general and specific health care topics is desirable to ensure a broad base of medical knowledge and to improve productivity and patient care. It is also preferential to provide a system that accesses the ongoing skills of the health care worker, thereby allowing the system to interact and provide more advanced information to a health care worker as he/she gains experience.

The systems as described in U.S. patents and pending application Ser. Nos. 6,997,717, 6,991,464, 6,978,115, 6,546,230, 6,539,269, 6,535,714, 5,791,907, 2006/0084043, 2006/0084042, 2005/0221263, 2003/0144877, 2003/0074559, 2003/0061070 and 2002/0069086 (all incorporated herein by reference in their entireties) provide computer based training systems. However, improved systems are needed that provided enhanced capabilities.

### SUMMARY OF THE INVENTION

The present invention provides computer implemented and interactive educational platforms for training professionals, such as healthcare workers. In particular, the present invention provides learning modules for professionals for implementing an interactive core curriculum that is designed to cover core competencies, preferably accessible in real-time.

Certain illustrative embodiments of the invention are described below. The present invention is not limited to these embodiments.

In some embodiments, the present invention provides a service provider that provides an educational, interactive platform for professionals (e.g., medical) that is easily accessible over a communication network (e.g., Internet, intranet, etc.) via computers and handheld or portable devices, either wireless or otherwise. In some embodiments, the platform provides for the tracking of patients seen by a clinical practitioner (e.g., medical student, intern, resident, attending physician, private physician, etc.) and tailoring a curriculum for that practitioner, such that the curriculum is based on, for example, the experience level of the clinician, including assessing the types and numbers of patients with particular characteristics that have been seen by the clinician so as to ensure both advanced learning and comprehensive learning. The system may also be configured to simultaneously manage the education of a large number of medical trainees, each with a customized experience, based on the type and number of work experiences they encounter.

In some embodiments, the service provides a database that contains educational modules. In some embodiments, the modules are tagged with one or more topic indicators that associate the topic of the module with one or more patient characteristics (e.g., disease or condition types, signs or symptoms, tissue types, infectious disease types, age, gender, patient history, family history, genetic information, risk profile, and the like). In some embodiments, modules associated with a topic are tagged with an advancement rating that signifies the level of complexity of the modules and/or are tagged with an “order” rating that signifies a sequence of modules to which the trainee should be exposed according to a particular curriculum. In some embodiments, the modules are tagged with a “field” designation that pertains to a topic of medical practice (e.g., pediatrics, oncology, endocrinology, surgery, emergency care, and the like) or a sub-topic of medical practice (e.g., transplant surgery, kidney transplant surgery, perioperative care for kidney transplant surgery, and the like).

In some embodiments, the service provides a processor (e.g., running software) and a database that tracks the experience of a practitioner and tracks the type of modules viewed by a practitioner as well as modules not viewed by the practitioner.

In some embodiments, the service provides a processor (e.g., running software) and a database that manages the delivery of modules to a practitioner based on the experiences of the practitioner. For example, in some embodiments, when a practitioner sees a patient, the practitioner enters patient characteristic information into a learning device (e.g., a handheld computing device). The processor receives this information (e.g., via wireless transmission from the learning device) and instructs a computer to transmit one or more educational modules associated with the patient characteristic to the learning device of the practitioner. The practitioner reviews the educational material and thus learns medically relevant information specific to the patient characteristic or characteristics the practitioner just encountered. The service stores information about which modules were viewed. When the practitioner encounters a second patient having the same or similar patient characteristic, the computer transmits a more advanced learning module so as to advance the learning associated with the characteristic. When a third patient is encountered with the patient characteristic, a yet more advanced module is provided. As such, a practitioner's learning is advanced quickly in areas directly corresponding to the type of patients seen. In some embodiments, the service also monitors topic areas that the practitioner has not encountered (e.g., because the practitioner has not been exposed to patients with characteristics associated with those topics). In such instances, educational modules are sent to the practitioner to ensure a broad range of learning. In some embodiments, these modules are provided at a rate and level of complexity commensurate with the minimum level of knowledge necessary to obtain core competencies associated with the particular educational trajectory of the practitioner. In some embodiments, these modules are provided at a rate and level of complexity based on a trainee's schedule (e.g., how far advanced in the particular educational trajectory, what particular training experience the trainee is presently engaged in, etc.). In some embodiments, the educational, interactive platform provides education modules that satisfy a core curriculum as defined by an accreditation entity including, but not limited to, practice-based learning and improvement. For example, core competencies are defined by the Accreditation Council for Graduate Medical Education (ACGME), the Commission on Dental Accreditation (CDA), the American Board of Opticianry (ABO), and other accreditation bodies.

When applied to a group of practitioners, the service ensures that each practitioner achieves learning modules for all core competencies, even if the practitioner is not exposed to patients that would otherwise cause the practitioner to learn such topics at the appropriate levels. Likewise, each practitioner is provided with advanced training in areas of interest or in areas in which frequent patient exposure permits and enhances such training. Each practitioner, based on their preferences, specializations, and directives, may receive a different combination or modules and/or different levels of complexities. In some embodiments, the service stores practitioner information permitting this individualized program, provided by the practitioner or their trainer or training institution. In some embodiments, the service provides reports to the practitioner, the trainer, or the training institution to show progress. Progress reports may be used for any number of purposes, including, but not limited to, grading, assignment to different patient types, and the like.

In some embodiments, the learning modules provide educational text, pictures, video, sound clips, or other multimedia information associated with the patient characteristic or characteristics encountered. In some embodiments, the module includes questions or quizzes to test learning of the information provided. In some embodiments, the module permits the practitioner to ask questions and have the questions answered (e.g., via answers stored in a database or by a trainer). In some embodiments, the module provides hyperlinks or other interactive elements that permit the practitioner to obtain additional information pertaining to any aspect of the information provided. In some embodiments, the module permits the practitioner to provide comments or patient-specific information that is stored either in the learning device or remotely. In some embodiments, the module permits the practitioner to suggest changes to the module that may be incorporated into future versions of the module. In some embodiments, the module permits the practitioner to make changes to the module that can be seen and evaluated by other users of the module.

In some embodiments, the interactive service is accessible through a desktop computer that is physically (e.g., by a cable) connected to a communication network or that houses a database and software that provides the service. More preferentially, handheld and other portable, wireless systems (e.g., cell phones, personal digital assistants, laptop computers, computer tablets or slates, etc.) are utilized. Such handheld and other portable devices are useful as practitioners visit patients, for example, in the setting of a hospital or other patient facility where multiple, sequential patient visits occur and access to desktop computers is limited.

In some embodiments, the present invention comprises a service provider comprising an educational, interactive platform accessible to professionals (e.g., medical) as exemplified in FIG. 1. In some embodiments, components of the service provider are configured to receive patient related information from a patient database. Patient information includes, but is not limited to, information concerning the patient as entered by a professional at each visit such as patient name, identification number, date of visit by the professional, primary diagnosis(es) at each visit, and any procedures, treatments, and the like performed on that patient during a particular visit. Patient information is provided to the service provider, for example, through a non-portable Internet capable device (e.g., desktop computer) or a handheld, portable wireless device (e.g., laptop computer, personal digital assistant, computer tablet or slate, and the like). In some embodiments, the service provider is configured not only to receive patient information entered by a professional at each visit, but is also configured to track all entered information from all visits thereby providing a log of entries (e.g., searchable entries) and updated information for a particular patient, which is communicated back to the patient record through the non-portable or portable device configured to receive updated patient information from the service provider. As such, current patient information from the source to the professional is maintained.

Components of the service provider provide, for example, educational, interactive platforms accessible to professionals in real-time. Initial platform related information is defined by, for example, by accreditation bodies, and/or a professor or other individual responsible for supplying the service provider with the required interactive educational information. In some embodiments, the service provider is configured to comprise information such as clinical vignettes whereby questions, answers, and explanations are offered a clinician based on the patient's particular presentation and diagnosis as entered by a user. Further information contained, or accessible through, a service provider comprises synopsis of diagnosis of a particular patient, as well as a checklist, for example, for clinicians to follow for reaching a diagnosis and for performing tests, treatments and the like. In some embodiments, the server also provides disease and illness associated vignettes to a clinician that the clinician has not yet encountered in his/her training, along with a synopsis for diagnosing the disease or illness, etc. As such, the present invention provides a learning system that tracks diseases and illness seen by a clinician, and fills in the gaps in the hands on experience of a clinician by providing the clinician with questions, explanations, and the like concerning diseases and illnesses he/she has not experienced first hand.

The present invention provides for the updating of the educational information provided by the service provider, such that the educational information offered a clinician is always kept up to date and current. This updating is provided by, for example, an individual who is in charge of keeping the service provider educational database current, and by the inputs of the clinician through logging of the patient information, and is performed on a periodic basis. In some embodiments, information obtained from the practitioners using the system is used to enhance the information content of the modules.

In some embodiments, the service also provides scheduling software intended for medical professionals, for example medical students, interns, residents, etc. In some embodiments, the scheduling software generates a large number of potential schedules based on a user's inputs, thereby providing optimal schedule choices to the user. In some embodiments, the scheduling software further chooses for the user the optimal schedule for the user. In some embodiments, scheduling is controlled to optimally correlate practitioner experience with patient types available or expected to be available (e.g., to fill in gaps in training or to provide advanced training or specialization).

The present invention provides systems for carrying out the services described herein. The systems may comprise one or more computer components, servers, software, databases, or other components useful, necessary, or sufficient for providing the services. The present invention also provides methods for conducting any of the services described herein, for example, employing the systems.

### DESCRIPTION OF THE FIGURES

FIG. 1 depicts an exemplary interactive system of the present invention.

### DEFINITIONS

To facilitate an understanding of the present invention, a number of terms and phrases are defined below:

As used herein the term “configured to receive” refers to a device that is capable of receiving information. Such devices contain one or more components that receive a signal carrying information. In the present invention, the service provider comprises the components configured to receive information as well as the components configured to transmit information to a user via the service provider. For example, a “service provider” is configured to receive information from a user and send to the user educational information relating to the user entry.

As used herein, the term “client-server” refers to a model of interaction in a distributed system in which a program at one site sends a request to a program at another site and waits for a response. The requesting program is called the “client,” and the program that responds to the request is called the “server.” In the context of the World Wide Web (discussed below), the client is a “Web browser” (or simply “browser”) that runs on a computer of a user; the program which responds to the browser requests by serving Web pages is commonly referred to as a “Web server.”

As used herein, the term “INTERNET” refers to any collection of networks using standard protocols. For example, the term includes a collection of interconnected (public and/or private) networks that are linked together by a set of standard protocols (such as RTP, TCP/IP, HTTP, and FTP) to form a global, distributed network. While this term is intended to refer to what is now commonly known as the INTERNET, it is also intended to encompass variations that may be made in the future, including changes and additions to existing standard protocols or integration with other media (e.g., television, radio, etc). The term is also intended to encompass non-public networks such as private (e.g., corporate) intranets.

As used herein, the “user” refers to a person who enters information into a system of the present invention. As such, as user includes, but is not limited to, healthcare workers such as medical students, medical interns, physician assistants and interns thereof, medical residents, attending physicians, private physicians, professors and the like responsible for the educational development of healthcare workers, etc.

### DETAILED DESCRIPTION OF THE INVENTION

Certain illustrative embodiments of the invention are described below. The present invention is not limited to these embodiments.

The present invention provides a system for interactive learning by professionals such as healthcare workers, for example, a medical student, intern, nursing student, resident, clinician (e.g., medical, dental, physician assistants, etc.), and the like. In some embodiments, the real-time, interactive learning is based on the development of an interactive core curriculum. The core curriculum is developed by a professional, for example the head of a medical department or a person responsible for the training and education of a healthcare worker. Alternatively, the development of the core curriculum is based on the requirements of an accreditation body of the particular healthcare worker, for example educational requirements as dictated by the Accreditation Council for Graduate Medical Education, the Commission on Dental Accreditation, the American Board of Opticianry, and other accreditation bodies. The system further provides a procedure log functionality, for example when a medical trainee enters patient related information (e.g., diagnosis, symptoms, procedures performed, tests performed, and the like), that information is logged and tracked in the system and is built on with additional entries by the trainee.

The present invention provides a computer implemented, interactive educational platform system for training professional workers, such as healthcare workers. In some embodiments, the system of the present invention comprises a service provider that is configured to receive information from a user and dispense information to a user (e.g., healthcare worker) based on the user-entered information, a device that is capable of communicating with the service provider, and an interactive core curriculum for the user comprising practice-based learning modules, vignettes, and the like for increasing the knowledge of the user.

The system further provides educational information to a user to fill in educational gaps in a user's real life patient related experiences by providing a user with information, for example, about diseases and illnesses the user (e.g., healthcare worker) has not experienced directly.

The system is configured to track patients seen by a practitioner and tailor a curriculum specifically to the practitioner based on his/her experience base that is deployed in real time. Moreover, the system provides for advanced learning options, wherein as the person learns more, the system adjusts accordingly and provides more detailed and advanced information to the user.

In some embodiments, the service provider that maintains the informational database is located onsite where training occurs (e.g., a specific hospital or medical facility) and serves a local user community, or offsite (e.g., for example a service provider located in another state from where the training is occurring) and provides a nationally accessible database for users nationwide. The service provider comprises software that allows for two-way communication between the user and the service provider, the service provider and the main database (e.g., a component of service provider) with the educational information. In some embodiments, the service provider is configured to be updated, for example, by one or more designated individuals (e.g., head of a department, professor, person in charge of the users' educational learning) or other mechanism(s) (e.g., download disease and illness related information periodically from a relevant on or offsite database, for example at the National Institute of Health and/or the Center for Disease Control, etc.), such that the service provider is periodically (e.g., daily, weekly, monthly, quarterly, etc.) updated with the most recent information concerning diseases or illnesses or other patient characteristic that a user might experience in interacting with a patient. The service provider is further updated internally, by tracking and updating patient information, for example, as entered by a user into the system.

In some embodiments, the service provider is configured to be updated by one or more users of the system such that the educational information in the informational database is kept current based on information from users' learning experiences (e.g., reading of new research publications) and patient related experiences (e.g., adverse effects of medical treatments), such that the changes are permanently included in the educational information in the informational database, and all future users of the system will see the updates. In some embodiments, the service provider is configured to be provisionally updated by one or more users of the system, based on their learning experiences and patient related experiences, such that other users or one or more designated individuals (e.g., head of a department, professor, person in charge of the users' educational learning) can judge the provisional changes and approve their permanent inclusion in the educational information in the informational database. In some embodiments, the service provider is configured to provide networking options such that a group of healthcare workers access the information and learning experiences of all the healthcare workers in a group, thereby allowing all healthcare workers to benefit from each person's patient related experiences.

In some embodiments, the service provider is configured to be updated by a user of the system such that changes in the educational information in the informational database made by the user are only seen if the same user accesses the same educational information again, and are not seen if other users access the educational material. This establishes the ability for each user to personalize the educational information for his/her own use.

In some embodiments, the service provider is configured to receive information as entered by a user on an Internet capable device, such as a desktop computer or a handheld, portable Internet capable device (e.g., laptop computer, personal digital assistant, computer tablet or slate, and the like). The service provider receives the information (e.g., patient related information) entered by the user, which includes, but is not limited to, symptoms, diagnosis, laboratory tests ordered and/or results, procedures performed, etc. The service provider receives the entered information, and based on its content provides the user (e.g., in real-time) with relevant clinical vignettes, diagnosis checklists, diagnosis synopsis, and the like such that the user is further educated on a particular disease or illness.

In some embodiments, the service provider tracks and updates patient related records and information as entered by a user, thereby constantly maintaining the most current log of information in the patient record as entered by a user. In some embodiments, the information logged by the user is searchable, either in real-time or at a later date, for example if a user wants to review a patient log for a particular aspect of treatment and the like. In some embodiments the service provider is configured to provide the user with increasingly advanced vignettes and disease/illness related information as the user becomes more advanced and educated about a particular disease or illness. As such, the service provider adjusts the information it supplies to a user based on the user's education level on a particular topic. In some embodiments, the service provider provides information to a user based on what the user has not seen while performing clinical or other healthcare work. A service provider, as it tracks the inputs of the healthcare worker, is configured to recognize gaps in the user's hands on education, and it furnishes information to the user to fill those learning gaps. As such, through the combination of real-time, hands on experience and virtual experience supplemented by the service provider, the user accomplishes the educational learning goals as defined by the core curriculum.

The system of the present invention comprises a device for communicating with the service provider. The device is Internet capable and is used by a user to enter, access, search, etc. patient information. In some embodiments, the device is a non-portable, but Internet capable, device such as a desktop computer. In preferred embodiments, the device is a portable, handheld device such as a wireless laptop computer, personal digital assistant, computer tablet or slate, and the like. Such handheld devices are useful in that they accompany a healthcare worker on patient visits where he/she enters real time information and receives real time feedback from the service provider while still at the patient's side. In some embodiments, a device of the present invention comprises software for two-way communication with the patient record and the service provider, a viewing device such as a screen for viewing patient information (e.g. text information, pictures, etc.) and information provided by the service provider, a method for entering information such as a keypad or touchpad, and is configured to store, maintain, track, and search patient and service provider furnished information and to allow updating as previously described.

In some embodiments, the system of the present invention further comprises interactive practice based learning and educational modules. In some embodiments, the content of the modules is developed using core competencies as dictated by an accreditation board, for example the Accreditation Council for Graduate Medical Education. In some embodiments, the content of the modules comprises educational materials deemed important by one or more people responsible for the education of the healthcare worker, for example a professor, head of a department, and the like. In some embodiments, the content of the modules comprises educational core competencies as dictated by an accreditation board as well as educational information considered important by one or more people responsible for the education of the user. Practice based learning and educational modules include, but are not limited to, modules that provide clinical vignettes or scenarios to a user (including but not limited to questions and explanations), modules that provide diagnostic synopsis for diseases and illnesses, and modules that provide checklists for a diagnosis such as checklists for a clinical to diagnose and treat a disease or illness. The information provided to the user, through the service provider, is relevant to the information entered by a user concerning a particular patient.

In some embodiments, the present invention provides scheduling software for healthcare professionals, such as medical students, interns, residents, doctors, etc. Scheduling software of embodiments of the present invention comprises the ability to generate large numbers of potential schedules (e.g., classes, patient rounds and visits, meetings, etc.) based on the user's inputs. In some embodiments, the software further comprises the ability to choose the best, or optimal, schedule for the user from among all the generated schedules. In some embodiments, the software uses the informational database of the service provider described above to help choose a schedule for the user, based on the user's prior learning and patient care experiences, as well as what the user has not seen during their experiences. In some embodiments, the software is installed and operates within an Internet capable non-portable device (e.g., desktop computer). In preferred embodiments the software is installed and operates within a portable wireless device (e.g., personal digital assistant, portable laptop computer, computer tablet or slate, cell phone, and the like). For example, a user enters a list of items that he/she wants to attend for a particular day, or week, or month, etc. Input items include, but are not limited to, a patient visit, a meeting time, a class time, a procedure or demonstration time the user wants to attend, etc. The software of the present invention, upon receiving the user input, generates one, a few, or many schedules that will accommodate as many, or all, of the desired items on the user's list. In some embodiments, the user chooses the schedule he/she wants. In some embodiments, the supervisor chooses the user's schedule. In some embodiments, the software chooses the optimal schedule and communicates (e.g., displays) that schedule to the user or a supervisor.

The following examples are provided in order to demonstrate and further illustrate certain preferred embodiments and aspects of the present invention and are not to be construed as limiting the scope thereof.

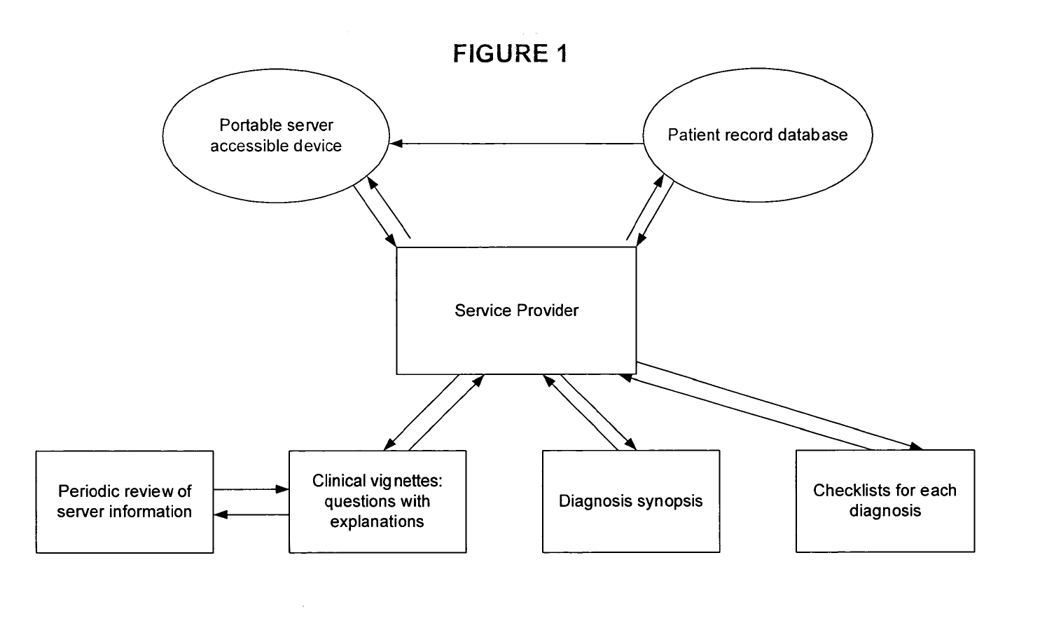

The following example depicts an embodiment of the present invention as exemplified in FIG. 1. A medical trainee, for example, carries a handheld computer slate on patient rounds for accessing and entering patient related information into the patient record, which is subsequently provided to a service provider configured to receive the information. The medical trainee visits a patient and enters into the device the patient's name, ID number, symptoms and diagnosis of the patient upon review of the patient's condition, thereby updating or adding to the patient record. The service provider receives the information entered by the medical trainee and provides, in real time, information back to the medical trainee in the form of clinical vignettes and questions about symptoms and/or diagnosis, based on the patient information entered by the trainee. As the trainee sees more of a particular disease or illness, and gains experience, information provided by the service provider back to the medical trainee becomes more advanced to account for the increased knowledge assimilated by the medical trainee concerning that particular disease or illness. The provision of more advanced educational materials provided the user by the service provider is based on the tracking of the patient information by the service provider, as entered by the user. The service provider also provides the medical trainee with checklists for each diagnosis and synopsis for each diagnosis to increase the knowledge base of the medical trainee.

In another example of an embodiment of the present invention, the medical trainee is provided with educational materials relating to diseases and illnesses he/she has not had direct experience with. For example, at the beginning of each week the service provider compiles the information entered by the medical trainee and is configured to recognize gaps in medical conditions that the medical trainee has not seen and offer the trainee the opportunity to fill those gaps. The service provider recognizes that the medical trainee has not seen, for example, a patient with pancreatitis and therefore has had no direct experience with this medical condition. As pancreatitis is part of the core curriculum, the service provider offers to provide the medical trainee with clinical vignettes including, but not limited to, questions and explanations about this condition, as well as a synopsis for the diagnosis of pancreatitis, and checklists for providing the diagnosis, tests to run, treatment courses for the condition, and the like. The user may choose to read these educational materials that week or defer until a later time. If at the start of a later week the service provider recognizes that the user has still not read the educational materials about pancreatitis, it may again offer to provide the medical trainee the educational materials. As such, either directly or indirectly, the medical trainee is offered and eventually receives educational materials for all aspects of a defined core curriculum.

All publications and patients mentioned in the present application are herein incorporated by reference. Various modifications and variations of the described methods and compositions of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

1. A system for training healthcare workers comprising a computer system comprising a processor and a database, wherein said processor is configured to: a) receive patient information from a trainee practitioner, said patient information comprising one or more patient characteristics; b) associate one or more educational modules stored in said database with said patient characteristic; and c) transmit said one or more educational modules to said trainee practitioner.

2. The system of claim 1, further comprising a handheld portable wireless device configured to send and receive information to and from said computer system.

3. The system of claim 1, wherein said one or more educational modules comprise core competencies for a healthcare worker.

4. The system of claim 1, wherein said database contains a plurality of educational modules associated with a patient characteristic, said plurality of educational modules differing in complexity of information contained therein.

5. The system of claim 4, wherein said processor identifies whether said trainee practitioner has previously received an education module(s) associated with a patient characteristic and wherein a more complex module is provided if a prior module(s) had previously been provided.

6. The system of claim 1, wherein said processor supplies one or more educational modules to said trainee practitioner that is not associated with a patient characteristic that said trainee practitioner has sent to said system.

7. The system of claim 6, wherein said processor identifies whether said trainee practitioner has previously received an education module(s) associated with a patient characteristic and wherein a module is provided if that module has not previously been provided.

8. The system of claim 7, wherein said processor periodically compiles a record of education modules not previously provided to said trainee practitioner and offers to provide one, some, or all of the modules.

9. The system of claim 8, wherein said processor periodically and repeatedly offers to provide said trainee practitioner with one, some, or all of the unprovided modules so that trainee practitioner is prompted to access all of a set of modules comprising a desired core curriculum by the end of a defined training period.

10. The system of claim 1, wherein said processor is configured to receive changes to the transmitted education module(s) from said trainee practitioner, either subject to or not subject to review by other trainees or educators prior to inclusion in the database, visible to all future users of the module(s).

11. The system of claim 1, wherein said processor is configured to receive changes to the transmitted education module(s) from said trainee practitioner, visible to said practitioner upon future access of the same module(s) but not visible to other users of the system.

12. The system of claim 1, further comprising a scheduling component configured to schedule training events for said trainee practitioner.

13. The system of claim 12, wherein the scheduling component generates a schedule for the trainee practitioner that includes training events not previously experienced by the trainee practitioner.

14. The system of claim 12, wherein the scheduling component generates a schedule for the trainee practitioner that includes training events that provide a more advanced training event than previously experienced by the trainee practitioner.

15. A method for interactive, educational training of healthcare workers comprising:
a) providing a service provider, wherein said service provider is configured to receive and send information, and wherein said service provider comprises interactive educational learning modules for healthcare workers,
b) providing a device to a healthcare worker, wherein said healthcare worker enters patient related information into said device configured to send said patient information to a service provider and receive an educational learning module(s) related to said patient related information from said service provider,
c) sending said patient information to said service provider, and
d) furnishing to said healthcare worker patient an educational learning module(s) based on said patient information entered by said healthcare worker.

16. The method of claim 15, wherein the content of said educational learning modules comprises core competencies as defined by a board of accreditation.

17. The method of claim 15, wherein said service provider identifies a medical topic associated with said patient related information and selects an educational learning module tagged as associated with said medical topic.

18. The method of claim 17, wherein said service provider identifies whether said healthcare worker has previously received an educational module associated with said medical topic.

19. The method of claim 18, wherein, if said healthcare worker has previously received an educational module associated with said medical topic, a more advanced educational module associated with said medical topic is provided to said healthcare worker.

20. The method of claim 15, wherein said service provider compiles a record of educational modules previously received by said healthcare worker and provides educational modules related to medical topics not previously received by said healthcare worker.
